(19) United States
(12) Patent Application Publication
(10) Pub. No.: US 2024/0404756 A1
(43) Pub. Date: Dec. 5, 2024

(54) MULTILAYER CERAMIC CAPACITOR

(71) Applicant: Murata Manufacturing Co., Ltd., Nagaokakyo-shi (JP)

(72) Inventor: Masaru TAKAHASHI, Nagaokakyo-shi (JP)

(21) Appl. No.: 18/800,367

(22) Filed: Aug. 12, 2024

Related U.S. Application Data
(63) Continuation of application No. PCT/JP2023/030997, filed on Aug. 28, 2023.

(30) Foreign Application Priority Data
Oct. 28, 2022 (JP) 2022-173161

(51) Int. Cl. H01G 4/232; H01G 4/005; H01G 4/12; H01G 4/224; H01G 4/30

(52) U.S. Cl. CPC H01G 4/2325; H01G 4/005; H01G 4/1227; H01G 4/224; H01G 4/30

(57) ABSTRACT

A multilayer ceramic capacitor includes a multilayer body, and external electrodes respectively provided on the two end surfaces of the multilayer body. The external electrodes each include a base electrode layer, a first plated layer on top of the base electrode layer, a second plated layer on top of the first plated layer, and an adhesive force mitigation layer located between the first plated layer and the second plated layer while allowing the second plated layer to be in contact with the first plated layer.

### CROSS REFERENCE TO RELATED APPLICATIONS

This application claims the benefit of priority to Japanese Patent Application No. 2022-173161, filed on Oct. 28, 2022, and is a Continuation Application of PCT Application No. PCT/JP2023/030997, filed on Aug. 28, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

In a situation where a circuit board is subjected to bending or flexing stress with a multilayer ceramic capacitor mounted thereon, the stress is transmitted to the capacitor body through an external electrode, potentially causing cracks in the capacitor body.

Japanese Unexamined Patent Application, Publication No. 2014-203910, for example, discloses disposing an adhesive force mitigation film between a baked metal film and a plated metal film in each external electrode in order to reduce the formation of cracks. The adhesive force mitigation film mitigates the adhesion force of the plated metal film with respect to a surface on which the plated metal film is formed. This configuration allows the plated metal film to separate from the baked metal film when the circuit board is deflected, thereby preventing or reducing the transmission of stress to the capacitor body.

However, once the plated metal film has separated from the baked metal film, the baked metal film is exposed to the outside air, leading to concern about deterioration of the capacitor body and other components due to moisture or other foreign substances infiltrating to the baked metal film.

### SUMMARY OF THE INVENTION

Example embodiments of the present invention provide multilayer ceramic capacitors that each make it possible to reduce an occurrence of cracks in the multilayer ceramic capacitors while ensuring high reliability.

An example embodiment of the present invention provide a multilayer ceramic capacitor including a multilayer body and external electrodes. The multilayer body includes dielectric layers and internal electrode layers alternately laminated therein. The multilayer body includes two main surfaces opposed to each other in a lamination direction, two end surfaces opposed to each other in a length direction orthogonal or substantially orthogonal to the lamination direction, and two lateral surfaces opposed to each other in a width direction orthogonal or substantially orthogonal to both the lamination direction and the length direction. The external electrodes are respectively provided on the two end surfaces of the multilayer body. Each of the external electrodes includes a base electrode layer, a first plated layer on top of the base electrode layer, a second plated layer on top of the first plated layer, and an adhesive force mitigation layer between the first plated layer and the second plated layer while allowing the second plated layer to be in contact with the first plated layer.

According to example embodiments of the present invention, it is possible to provide multilayer ceramic capacitors that each make it possible to reduce an occurrence of cracks in the multilayer ceramic capacitor while ensuring high reliability.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor according to one example embodiment of the present invention mounted on a circuit board.

FIG. 2A is a partially enlarged view of a cross-section taken along line II-II in FIG. 1 showing the multilayer ceramic capacitor according to the one example embodiment of the present invention mounted on the circuit board, and shows a first external electrode and an area therearound in a state where a first plated layer and a second plated layer are bonded together.

FIG. 2B is a partially enlarged view of a cross-section taken along line II-II in FIG. 1, and shows a second external electrode and an area therearound in a state where a first plated layer and a second plated layer are separate from each other.

FIG. 3 is a diagram corresponding to FIG. 2A and showing a configuration of a multilayer ceramic capacitor according to a modified example of the present invention.

FIG. 4 is a diagram corresponding to FIG. 2A and showing a configuration of a multilayer ceramic capacitor according to another modified example of the present invention.

### DETAILED DESCRIPTION OF THE EXAMPLE EMBODIMENTS

Example embodiments of the present invention will be described in detail with reference to the drawings.

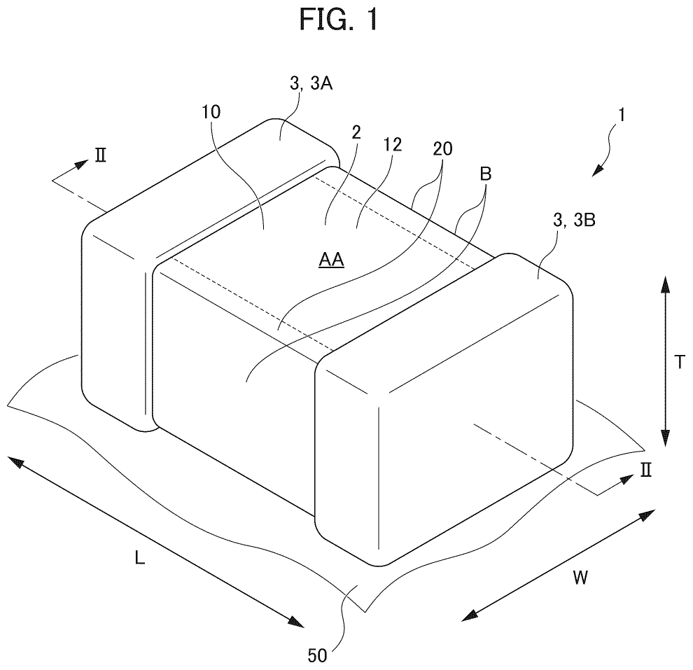

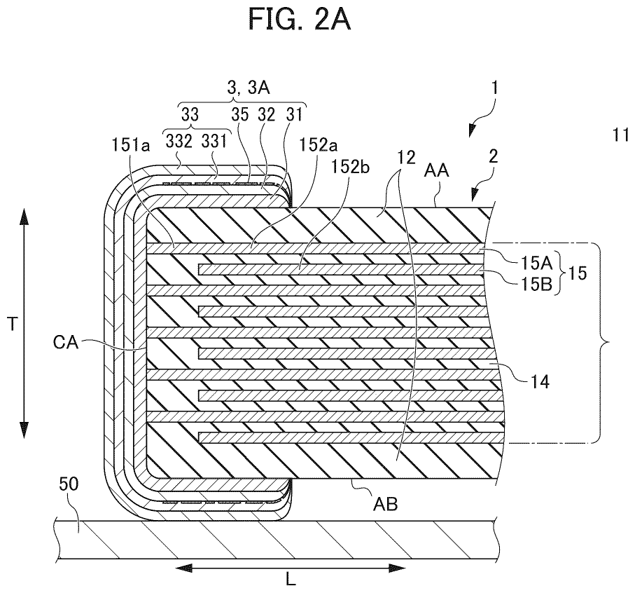

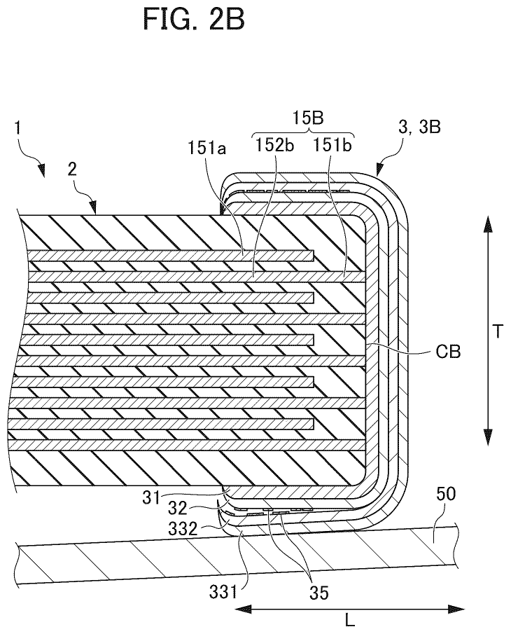

The following describes an example embodiment of the present invention based on FIGS. 1 and 2.

### Multilayer Ceramic Capacitor

As shown in FIGS. 1 and 2, a multilayer ceramic capacitor 1 has a rectangular or substantially rectangular parallelepiped shape, and includes a multilayer body 2 and a pair of external electrodes 3 provided at opposite ends of the multilayer body 2. The multilayer ceramic capacitor 1 is preferably mounted on a circuit board 50.

The following terms are used to indicate directions in the multilayer ceramic capacitor 1 in the description below. A direction in which the pair of external electrodes 3 are arranged in the multilayer ceramic capacitor 1 is referred to as a length direction L. A direction in which dielectric layers 14 and internal electrode layers 15 are laminated is referred to as a lamination direction T. A direction that intersects both the length direction L and the lamination direction T is referred to as a width direction W. In the present example embodiment, the width direction W is orthogonal or substantially orthogonal to both the length direction L and the lamination direction T.

Furthermore, six outer surfaces of the multilayer body 2 shown in FIG. 1 are distinguished as follows in the description below. A pair of outer surfaces opposed to each other in the lamination direction T is referred to as two main surfaces A. A pair of outer surfaces opposed to each other in the width direction W is referred to as two lateral surfaces B. A pair of outer surfaces opposed to each other in the length direction L is referred to as two end surfaces C. One of the two main surfaces A is referred to as a first main surface AA, and the other is referred to as a second main surface AB (see FIG. 2A). One of the two end surfaces C is referred to as a first end surface CA, and the other is referred to as a second end surface CB. The first main surface AA and the second main surface AB will be referred to collectively as the main surfaces A unless it is necessary to distinguish between the two main surfaces. The first end surface CA and the second end surface CB will be referred to collectively as the end surfaces C unless it is necessary to distinguish between the two end surfaces. It should be noted that the circuit board 50 is located on the second main surface AB side of the multilayer ceramic capacitor 1.

### Multilayer Body

The multilayer body 2 includes a multilayer body main portion 10 and side margin portions 20.

### Multilayer Body Main Portion

The multilayer body main portion 10 includes an inner layer portion 11 and outer layer portions 12 respectively located on two sides of the inner layer portion 11 that respectively oppose the main surfaces A.

### Inner Layer Portion

The inner layer portion 11 includes a plurality of dielectric layers 14 and a plurality of internal electrode layers 15 laminated therein.

Dielectric Layers The dielectric layers 14 are made of a ceramic material. Examples of usable ceramic materials include a dielectric ceramic containing BaTiO₃ as a main component. The ceramic material may include at least one subcomponent selected from, for example, a Mn compound, an Fe compound, a Cr compound, a Co compound, and a Ni compound in addition to the main component.

### Internal Electrode Layers

The internal electrode layers 15 include a plurality of first internal electrode layers 15A and a plurality of second internal electrode layers 15B. The first internal electrode layers 15A and the second internal electrode layers 15B are provided alternately. The first internal electrode layers 15A and the second internal electrode layers 15B will be referred to collectively as the internal electrode layers 15 unless it is necessary to distinguish between the first and second internal electrode layers.

Preferably, the internal electrode layers 15 are made from, for example, a metallic material such as Ni, Cu, Ag, Pd, a Ag—Pd alloy, or Au.

Each of the first internal electrode layers 15A includes a first counter portion 152a located opposite to adjacent second internal electrode layers 15B and a first extension portion 151a extending from the first counter portion 152a toward the first end surface CA. An end of the first extension portion 151a is exposed at the first end surface CA and electrically connected to a first external electrode 3A described below.

Each of the second internal electrode layers 15B includes a second counter portion 152b located opposite to adjacent first internal electrode layers 15A and a second extension portion 151b extending from the second counter portion 152b toward the second end surface CB. An end of the second extension portion 151b is electrically connected to a second external electrode 3B described below.

In the configuration of the internal electrode layers 15 described above, charge is accumulated in the first counter portions 152a of the first internal electrode layers 15A and the second counter portions 152b of the second internal electrode layers 15B, resulting in generating a capacitance.

The outer layer portions 12 are made of the same dielectric ceramic material as the dielectric layers 14 of the inner layer portion 11.

### Side Margin Portions

The side margin portions 20 are respectively provided on the opposite lateral surfaces B sides of a section where the inner layer portion 11 and the outer layer portions 12 are laminated. The side margin portions 20 extend along and cover ends of the internal electrode layers 15 in the width direction W that are exposed at the opposite lateral surfaces of the multilayer body main portion 10. The side margin portions 20 are made of the same dielectric ceramic material as the dielectric layers 14.

### External Electrodes

The external electrodes 3 include the first external electrode 3A provided on the first end surface CA of the multilayer body 2 and the second external electrode 3B provided on the second end surface CB of the multilayer body 2. The first external electrode 3A and the second external electrode 3B will be referred to collectively as the external electrodes 3 unless it is necessary to distinguish between the two external electrodes. The external electrodes 3 cover not only the end surfaces C but also parts of the main surfaces A and the lateral surfaces B adjacent to the end surfaces C.

Each of the external electrodes 3 includes a base electrode layer 31, a first plated layer 32 located on top of the base electrode layer 31, a second plated layer 33 located on top of the first plated layer 32, and an adhesive force mitigation layer 35 located between the first plated layer 32 and the second plated layer 33.

The base electrode layer 31 is preferably, for example, formed by applying and baking an electrically conductive paste containing an electrically conductive metal and glass. Examples of electrically conductive metals usable for the base electrode layer 31 include Cu, Ni, Ag, Pd, a Ag—Pd alloy, and Au.

The first plated layer 32 is, for example, a Cu plated layer. As such, the first plated layer 32 can suitably prevent or reduce infiltration of moisture to the base electrode layer 31.

The second plated layer 33 includes an inner second plated layer 331 and an outer second plated layer 332 located on top of the inner second plated layer 331 while being in contact with the inner second plated layer 331.

The inner second plated layer 331 is, for example, a Ni plated layer. As such, the inner second plated layer 331 reduces likelihood of corrosion of the base electrode layer 31 and the adhesive force mitigation layer 35 by solder when the multilayer ceramic capacitor 1 is mounted on the circuit board 50.

The outer second plated layer 332 is, for example, a Sn plated layer. As such, the outer second plated layer 332 enhances the wettability of solder when the multilayer ceramic capacitor 1 is mounted on the circuit board 50, making it easy to mount the multilayer ceramic capacitor 1.

The adhesive force mitigation layer 35 is capable of mitigating the adhesion force between the first plated layer 32 and the second plated layer 33 (more specifically, the inner second plated layer 331). As such, when the circuit board 50 is deflected, the adhesive force mitigation layer 35 allows the first plated layer 32 to suitably separate from the second plated layer 33 in an area where the adhesive force mitigation layer 35 is provided. The adhesive force mitigation layer 35 contains an organosilicon compound. Preferably, the organosilicon compound is, for example, a multifunctional alkoxysilane Si—(CₙH₂ₙ₊₁)₃. As such, the adhesive force mitigation layer can be located on a surface of the first plated layer 32 more reliably, making it possible to suitably reduce the formation of cracks in the multilayer body 2. Such an adhesive force mitigation layer also makes it possible to prevent or reduce defective plating and restrict detachment of the multilayer ceramic capacitor 1.

Specifically, the adhesive force mitigation layer 35 is provided in areas between the first plated layer 32 and the second plated layer 33 where the first plated layer 32 and the second plated layer 33 cover the main surfaces A. Although not shown, the adhesive force mitigation layer 35 has an annular shape and is also provided in areas between the first plated layer 32 and the second plated layer 33 where the first plated layer 32 and the second plated layer 33 cover the lateral surfaces B. The adhesive force mitigation layer 35 only needs to be provided at least in the area where the first plated layer 32 and the second plated layer 33 cover the second main surface AB, and is not necessarily needed in the area where the first plated layer 32 and the second plated layer 33 cover the first main surface AA or in the areas where the first plated layer 32 and the second plated layer 33 cover the lateral surfaces B.

The adhesive force mitigation layer 35 includes a plurality of voids that penetrate through in the thickness direction of the layer. In other words, the adhesive force mitigation layer 35 has a porous structure. The first plated layer 32 and the second plated layer 33 are in contact with each other through the voids. The first plated layer 32 and the second plated layer 33 are therefore electrically conductive through such contact areas.

Preferably, for example, the first plated layer 32 has a surface roughness in the range of about 0.10 μm to about 0.27 μm at least on the surface opposed to the adhesive force mitigation layer 35. This range of surface roughness allows the ease of separation between the first plated layer 32 and the second plated layer 33 to be within an appropriate range.

When the circuit board 50 is deflected, as shown in FIG. 2B, the first plated layer 32 and the second plated layer 33 can separate from each other in an area where the adhesive force mitigation layer 35 is provided (referred to below simply as a “separated state”). Even in the separated state, the first plated layer 32 covers the base electrode layer 31. Thus, moisture infiltration, for example, to or beyond the base electrode layer 31 can be prevented or reduced, thereby preventing or reducing degradation of the multilayer ceramic capacitor 1.

When the first plated layer 32 and the second plated layer 33 are in the separated state, for example, the adhesive force mitigation layer 35 is expected to be in a torn state, with segments thereof adhering to each plated layer. However, the state of the adhesive force mitigation layer 35 when the first plated layer 32 and the second plated layer 33 are in the separated state is not particularly limited, and the adhesive force mitigation layer 35 may be in a state in which the entirety thereof adheres to either the first plated layer 32 or the second plated layer 33.

### Multilayer Ceramic Capacitor Manufacturing Method

The following describes an example of a manufacturing method for the multilayer ceramic capacitor 1. The manufacturing method for the multilayer ceramic capacitor 1 includes a multilayer body production step and an external electrode formation step.

### Multilayer Body Production Step

First, lamination ceramic green sheets are prepared by forming a ceramic slurry into a sheet shape. An electrical conductor paste is placed on each lamination ceramic green sheet to print a pattern of the internal electrode layers 15 thereon. As a result, material sheets are obtained.

Next, a plurality of material sheets are stacked so that the internal electrode patterns thereon are offset by half a pitch in the length direction between adjacent material sheets. Next, ceramic green sheets for respectively forming the outer layer portions are stacked so as to sandwich the plurality of material sheets stacked, followed by thermal compression bonding. As a result, a mother block material is obtained.

Next, the mother block material is cut along cutting lines corresponding to dimensions of the multilayer body. As a result, a plurality of multilayer chips are obtained. Thereafter, corner portions and ridge portions of each multilayer chip may be rounded by barrel polishing or other method.

Next, the plurality of multilayer chips are fired. Through the processes described above, the multilayer body 2 having the multilayer body main portion 10 and the side margin portions 20 is obtained. The firing temperature depends on the materials of the dielectric layers 14 and the internal electrode layers 15, but is, for example, preferably about 900° C. or higher and about 1400° C. or lower.

### External Electrode Formation Step

First, the base electrode layer 31 is formed on each of the end surfaces C of the multilayer body 2. The end surfaces C of the multilayer body 2 are in turn immersed in an electrically conductive paste, which is an electrode material for the base electrode layer. As a result, the electrically conductive paste is applied onto each of the end surfaces C of the multilayer body 2. Thereafter, the electrically conductive paste on the end surfaces C is fired together with the multilayer body 2. As a result, the base electrode layer 31 is formed on each of the end surfaces C of the multilayer body 2. The firing temperature is, for example, preferably about 600° C. or higher and about 900° C. or lower. The multilayer body 2 and the external electrodes 3 may be fired simultaneously.

Next, the first plated layer 32 is formed on top of the base electrode layer 31. The first plated layer 32 is formed so that ends of the first plated layer 32 adjacent to the main surfaces A and the lateral surfaces B cover ends of the base electrode layer 31 adjacent to the main surfaces A and the lateral surfaces B. The first plated layer 32 can be, for example, formed by electrolytic plating or electroless plating.

Next, the adhesive force mitigation layer 35 is located on top of the first plated layer 32. A first organic treatment liquid and a second organic treatment liquid are used to form the adhesive force mitigation layer 35. First, the first organic treatment liquid is applied onto the first plated layer 32. The first organic treatment liquid preferably includes, for example, an organosilicon compound. The organosilicon compound is a silane coupling agent. Examples of organosilicon compounds (silane coupling agents) include decyltrimethoxysilane, n-propyltrimethoxysilane, and octyltriethoxysilane. The first organic treatment liquid can be, for example, applied by screen printing. Thereafter, the first organic treatment liquid is dried at, for example, a temperature of about 100° C. to about 200° C.

After the first organic treatment liquid has been dried, the second organic treatment liquid is applied. The second organic treatment liquid contains an organosilicon compound. Preferably, the second organic treatment liquid contains a multifunctional alkoxysilane Si—(CₙH₂ₙ₊₁)₃. The second organic treatment liquid can be, for example, applied by screen printing. Thereafter, the second organic treatment liquid is dried at a temperature of, for example, about 100° C. to about 200° C. The first organic treatment liquid and the second organic treatment liquid that have been dried on the first plated layer 32 define and function as the adhesive force mitigation layer 35. The method for applying the first organic treatment liquid and the second organic treatment liquid is not limited to screen printing. For example, a dipping method may be employed in which the application object is immersed in each organic treatment liquid. Portions of the adhesive force mitigation layer that are located in areas where the adhesive force mitigation layer is not desired can be removed by polishing or other method. The number and the size of the voids in the adhesive force mitigation layer 35 can be adjusted by adjusting the application amount of the first organic treatment liquid and the second organic treatment liquid. The number of the voids decreases and the size of the voids decreases with an increase in the application amount of the first organic treatment liquid and the second organic treatment liquid. The number of the voids increases and the size of the voids increases with a decrease in the application amount of the first organic treatment liquid and the second organic treatment liquid.

Next, the inner second plated layer 331 is formed on top of the first plated layer 32 and the adhesive force mitigation layer 35. The inner second plated layer 331 is formed so that ends of the inner second plated layer 331 adjacent to the main surfaces A and the lateral surfaces B cover ends of the first plated layer 32 and the adhesive force mitigation layer 35 adjacent to the main surfaces A and the lateral surfaces B. The inner second plated layer 331 can be, for example, formed by electrolytic plating.

Next, the outer second plated layer 332 is formed on top of the inner second plated layer 331. The outer second plated layer 332 is formed so that ends of the outer second plated layer 332 adjacent to the main surfaces A and the lateral surfaces B cover ends of the adhesive force mitigation layer 35 adjacent to the main surfaces A and the lateral surfaces B. The outer second plated layer 332 can be, for example, formed by electrolytic plating. Through the processes described above, each external electrode 3 is formed.

### Advantageous Effects

The example embodiments described above produce the following advantageous effects.

According to the example embodiment described above, each of the external electrodes 3 includes a base electrode layer 31, a first plated layer 32 located on top of the base electrode layer 31, a second plated layer 33 located on top of the first plated layer 32, and an adhesive force mitigation layer 35 located between the first plated layer 32 and the second plated layer 33 while allowing the second plated layer 33 to be in contact with the first plated layer 32. The adhesive force mitigation layer 35 is capable of mitigating the adhesion force between the first plated layer 32 and the second plated layer 33. As such, the adhesive force mitigation layer 35 allows the first plated layer 32 and the second plated layer 33 to separate from each other due to the stress exerted thereon when the circuit board 50 with the multilayer ceramic capacitor 1 mounted thereon is deflected. Thus, the formation of cracks in the multilayer ceramic capacitor 1 can be reduced or prevented.

The base electrode layer 31 remains covered by the first plated layer 32 even after the first plated layer 32 and the second plated layer 33 have separated from each other. Thus, moisture infiltration, for example, to or beyond the base electrode layer 31 can be prevented or reduced, thereby preventing or reducing degradation of the multilayer ceramic capacitor 1. It is therefore possible to ensure high reliability of the multilayer ceramic capacitor 1.

According to the example embodiment described above, the first plated layer 32 is, for example, preferably a Cu plated layer. As such, the first plated layer 32 can suitably prevent or reduce moisture infiltration to the base electrode layer 31.

According to the example embodiment described above, the inner second plated layer 331 is, for example, preferably a Ni plated layer. As such, the inner second plated layer 331 reduces likelihood of corrosion of the base electrode layer 31 and the adhesive force mitigation layer 35 by solder when the multilayer ceramic capacitor 1 is mounted on the circuit board 50.

According to the example embodiment described above, the outer second plated layer 332 is, for example, preferably a Sn plated layer. As such, the outer second plated layer 332 enhances the wettability of solder when the multilayer ceramic capacitor 1 is mounted on the circuit board 50, making it easy to mount the multilayer ceramic capacitor 1.

According to the example embodiment described above, the adhesive force mitigation layer 35 includes, for example, an organosilicon compound. As such, the adhesive force mitigation layer 35 makes it possible to suitably reduce the formation of cracks in the multilayer body 2. Such an adhesive force mitigation layer also makes it possible to prevent or reduce defective plating and restrict detachment of the multilayer ceramic capacitor 1.

According to the example embodiment described above, the organosilicon compound is, for example, a multifunctional alkoxysilane. As such, the adhesive force mitigation layer 35 makes it possible to prevent or reduce the formation of cracks in the multilayer body 2 more suitably, and to prevent or reduce defective plating and restrict detachment of the multilayer ceramic capacitor 1 more suitably.

According to the example embodiment described above, the first plated layer 32 has, for example, a surface roughness Sa of about 0.10 μm or more and about 0.27 μm or less.

This range of surface roughness allows the ease of separation between the first plated layer 32 and the second plated layer 33 to be within an appropriate range.

According to the example embodiment described above, the adhesive force mitigation layer 35 between the first plated layer 32 and the second plated layer 33 is provided in areas located over outer areas of the main surfaces A and in areas located over outer areas of the lateral surfaces B, and is not provided in areas located over outer areas of the corresponding end surface C. As such, the adhesive force mitigation layer 35 allows the adhesion force between the first plated layer 32 and the second plated layer 33 to be an appropriate strength, suitably restricting detachment of the multilayer ceramic capacitor 1.

### Modifications

A preferred example embodiment and variations of the present invention have been described above. However, the present invention is not limited thereto and encompasses the following scope.

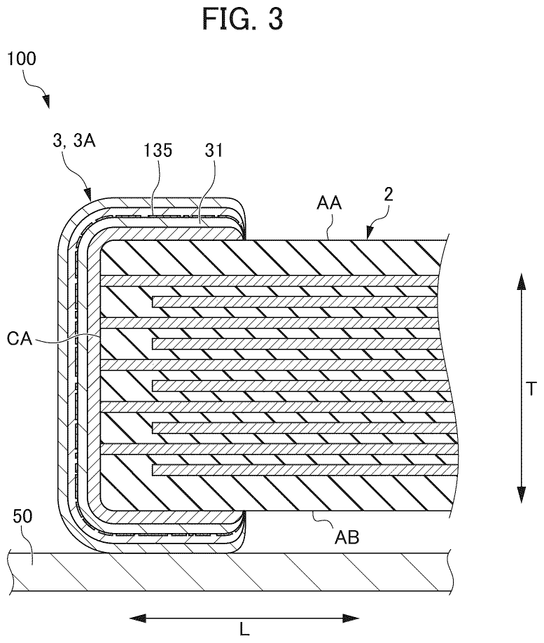

According to the example embodiment described above, the adhesive force mitigation layer 35 between the first plated layer 32 and the second plated layer 33 is provided in areas located over outer areas of the main surfaces A of the multilayer body 2 and in areas located over outer areas of the lateral surfaces B, and is not provided in areas located over outer areas of the corresponding end surface C. However, the present invention is not limited as such. For example, as illustrated in FIG. 3, a multilayer ceramic capacitor 100 includes an adhesive force mitigation layer 135. The adhesive force mitigation layer 135 is provided to cover the entire or substantially the entire area between the first plated layer 32 and the second plated layer 33. In this case, for example, the adhesive force mitigation layer can be formed readily by using a dipping method. However, the configuration of the foregoing example embodiment is more preferable because the foregoing example embodiment more suitably reduces the likelihood of the second plated layer coming loose from the multilayer ceramic capacitor.

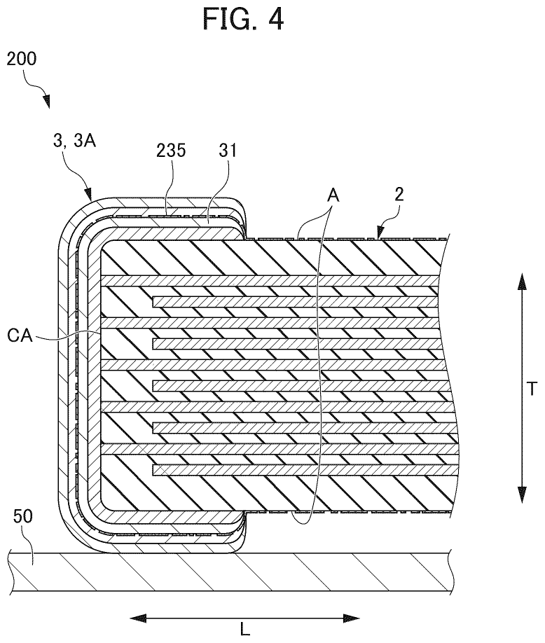

Furthermore, the adhesive force mitigation layer may extend beyond the area between the first plated layer 32 and the second plated layer 33. For example, as illustrated in FIG. 4, a multilayer ceramic capacitor 200 includes an adhesive force mitigation layer 235. The adhesive force mitigation layer 235 is provided to cover the entirety of the outer side of the first plated layer 32 and to cover the entirety or substantially the entirety of the outer side of each of the main surfaces A and the lateral surfaces B of the multilayer body 2. In this case, for example, the adhesive force mitigation layer can be formed more readily by using a dipping method. However, the configuration of the foregoing example embodiment is more preferable because the foregoing example embodiment more suitably reduces the likelihood of the second plated layer coming loose from the multilayer ceramic capacitor.

According to the example embodiment described above, the adhesive force mitigation layer 35 includes, for example, an organosilicon compound. However, the present invention is not limited as such. For example, the adhesive force mitigation layer may be a metal. However, the configuration of the foregoing example embodiment is more preferable because the foregoing example embodiment makes it possible to reduce the formation of cracks in the multilayer ceramic capacitor more suitably.

According to the example embodiment described above, the first plated layer 32 has a single layer structure. However, the first plated layer 32 may include a plurality of layers. In a configuration in which the first plated layer includes a plurality of layers, preferably, the outermost layer among the plurality of layers has a surface roughness Sa of, for example, about 0.10 μm or more and about 0.27 μm or less.

According to the example embodiment described above, the second plated layer 33 includes the inner second plated layer 331 and the outer second plated layer 332. However, the second plated layer 33 may have a single layer structure, or may include three or more layers.

Preferred example embodiments, variations, and modifications of the present invention have been described above. However, the present invention is not limited thereto and encompasses the following scope.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including dielectric layers and internal electrode layers alternately laminated therein, the multilayer body including two main surfaces opposed to each other in a lamination direction, two end surfaces opposed to each other in a length direction orthogonal or substantially orthogonal to the lamination direction, and two lateral surfaces opposed to each other in a width direction orthogonal or substantially orthogonal to both the lamination direction and the length direction; and
external electrodes respectively provided on the two end surfaces of the multilayer body; wherein
each of the external electrodes includes a base electrode layer, a first plated layer on top of the base electrode layer, a second plated layer on top of the first plated layer, and an adhesive force mitigation layer between the first plated layer and the second plated layer while allowing the second plated layer to be in contact with the first plated layer.

2. The multilayer ceramic capacitor according to claim 1, wherein the second plated layer includes an inner second plated layer and an outer second plated layer on top of the inner second plated layer.

3. The multilayer ceramic capacitor according to claim 2, wherein
the first plated layer is a Cu plated layer;
the inner second plated layer is a Ni plated layer; and
the outer second plated layer is a Sn plated layer.

4. The multilayer ceramic capacitor according to claim 1, wherein the adhesive force mitigation layer includes an organosilicon compound.

5. The multilayer ceramic capacitor according to claim 4, wherein the organosilicon compound is a multifunctional alkoxysilane.

6. The multilayer ceramic capacitor according to claim 1, wherein the first plated layer has a surface roughness of about 0.10 μm or more and about 0.27 μm or less.

7. The multilayer ceramic capacitor according to claim 1, wherein the adhesive force mitigation layer between the first plated layer and the second plated layer is provided in areas located over outer areas of the main surfaces and in areas located over outer areas of the lateral surfaces, and is not provided in areas located over outer areas of the corresponding end surface.

8. The multilayer ceramic capacitor according to claim 1, wherein the dielectric layers include a ceramic material.

9. The multilayer ceramic capacitor according to claim 8, wherein
the ceramic material includes:
BaTiO₃ as a main component; and
at least one subcomponent selected from a Mn compound, an Fe compound, a Cr compound, a Co compound, or a Ni compound.

10. The multilayer ceramic capacitor according to claim 1, wherein
the multilayer body further includes an outer layer portion; and
the dielectric layers and the outer layer portion include a same ceramic material.

11. The multilayer ceramic capacitor according to claim 1, wherein the adhesive force mitigation layer has a porous structure.
